(19) United States
(12) Patent Application Publication
(10) Pub. No.: US 2022/0165248 A1
(43) Pub. Date: May 26, 2022

(54) VOICE SYNTHESIS APPARATUS, VOICE SYNTHESIS METHOD, AND VOICE SYNTHESIS PROGRAM

(71) Applicant: Hitachi, Ltd., Tokyo (JP)

(72) Inventors: Qinghua SUN, Tokyo (JP); Takashi SUMIYOSHI, Tokyo (JP)

(21) Appl. No.: 17/518,628

(22) Filed: Nov. 4, 2021

(30) Foreign Application Priority Data
Nov. 20, 2020 (JP) 2020-192958

(51) Int. Cl. G10L 13/02

(52) U.S. Cl. CPC G10L 13/02; G10L 13/08

(57) ABSTRACT

To ensure optimization of a voice output timing. A voice synthesis apparatus that performs voice synthesis based on a statistical acoustic model includes a processor that executes a program and a storage device that stores the program. The voice synthesis apparatus performs a selection process and a synthesis process. The selection process selects a synthesis method applied to an input voice among a plurality of synthesis methods in combination of sizes of the statistical acoustic models with voice synthesis processes based on the input voice. The synthesis process synthesizes the input voice by the synthesis method selected in the selection process.

### CLAIM OF PRIORITY

The present application claims priority from Japanese patent application JP 2020-192958 filed on Nov. 20, 2020, the content of which is hereby incorporated by reference into this application.

### BACKGROUND

The present invention relates to a voice synthesis apparatus, a voice synthesis method, and a voice synthesis program that perform voice synthesis.

Introduction of voice synthesis based on Deep Neural Network (DNN) has allowed, not only improvement in sound quality of synthesized voice, but voice synthesis in multiple languages, multiple speakers, and multiple utterance styles. However, compared with the conventional method, an amount of calculation increases and a voice synthesis time period lengthens. Meanwhile, as well as the sound quality of synthesized voice, a timing (a response) of voice output is considerably important for a voice interaction device, such as a smart speaker and a communication robot.

Japanese Unexamined Patent Application Publication No. 2019-45831 discloses a voice processing device that outputs filler information to a user until an output of a response voice to an utterance voice of the user starts. This voice processing device obtains utterance voice data related to the utterance voice of the user under control by a voice data obtaining unit and an utterance voice data extracting unit. Under control by a response preparation time period predicting unit, based on a user utterance time period based on this utterance voice data and information on response content data related to the past utterance voice, a first time period required to recognize an utterance voice related to the utterance voice data, a second time period required to generate the response content data, and a third time period required to synthesize the response voice are predicted. Based on the predicted first, second, and third time periods, a delay time period required from a time point of ending the utterance voice of the user until the output of the response voice starts is predicted. Under control by a filler information output unit, filler voice data according to the predicted delay time period is output to a speaker within the delay time period.

Japanese Unexamined Patent Application Publication No. 2006-10849 discloses a voice synthesis apparatus that performs synthesis meeting a request by the dynamic request, such as a target generation time period taken for synthesized voice, a load on a central processing arithmetic unit of the voice synthesis apparatus, or a quality of the synthesized voice. This voice synthesis apparatus includes a memory that stores a compressed voice segment and a non-compressed voice segment corresponding the compressed voice segment, or a difference voice segment based on a difference between the compressed voice segment and the non-compressed voice segment corresponding to the compressed voice segment and the compressed voice segment, a voice segment selecting unit that selects the voice segment stored in the memory, and a voice segment generating unit that reads any one of the compressed voice segment and the non-compressed voice segment based on the selection by the voice segment selecting unit.

### SUMMARY

The response of the voice synthesis is a trade-off between the amount of calculation and the sound quality. In a case where the response is improved by parallel processing or the like, a burden on a server increases, resulting in reduction in performance of the entire server. Meanwhile, use of a high-response, lightweight (the low amount of calculation) synthesis system deteriorates a synthesis sound quality. Therefore, there has been a problem that dynamically controls a balance between the response of voice synthesis, the sound quality, and a throughput (the burden on the server) as necessary. Especially, the response of the voice synthesis also depends on an input text and therefore is not always constant, making the problem complicated.

In Japanese Unexamined Patent Application Publication No. 2019-45831, the voice recognition and the response time of the voice synthesis are predicted using the past data and the filler information can be output to the user using the result until the output of the response voice to the utterance voice of the user starts. That is, this is not a method that controls the response of the voice synthesis. Meanwhile, in Japanese Unexamined Patent Application Publication No. 2006-10849, the synthesis time period is controlled by dynamically selecting the compressed segment and the non-compressed segment, but a segment selection type voice synthesis is assumed, and therefore the method is not applicable to statistic-based voice synthesis, such as voice synthesis based on a DNN acoustic model.

An object of the present invention is to ensure optimization of a voice output timing.

A voice synthesis apparatus according to one aspect of the present invention disclosed in this application is a voice synthesis apparatus that performs voice synthesis based on a statistical acoustic model and includes a processor and a storage device. The processor executes a program. The storage device stores the program. The processor executes a selection process and a synthesis process. The selection process selects a synthesis method applied to an input voice among multiple synthesis methods in combination of sizes of the statistical acoustic models with voice synthesis processes based on the input voice. The synthesis process synthesizes the input voice by the synthesis method selected in the selection process.

With representative embodiments of the present invention, an optimization of a voice output timing can be achieved. Objects, configurations, and effects other than the above-described ones will be made apparent from the description of the embodiments below.

### BRIEF DESCRIPTION OF THE DRAWINGS

FIG. 1 is an explanatory view illustrating a hardware configuration example of a computer;

FIG. 2 is an explanatory view illustrating a system configuration example of a voice synthesis system;

FIG. 3 is an explanatory view illustrating an internal processing example of voice synthesis based on a DNN acoustic model by batch processing;

FIG. 4 is an explanatory view illustrating an internal processing example of the voice synthesis based on the DNN acoustic model by streaming process;

FIG. 5 is an explanatory view illustrating real-time performance of the voice synthesis by batch processing;

FIG. 6 is a table showing a relationship between a response time, a burden on a voice synthesis apparatus, and a synthesis sound quality; and a head phrase length, a model size, and a process method for the voice synthesis;

FIG. 7 is a block diagram illustrating a functional configuration example of the voice synthesis apparatus;

FIG. 8 is an explanatory view illustrating an example of a sample input text table;

FIG. 9 is a graph illustrating measurement results of the response time;

FIG. 10 is a graph illustrating measurement results of a RTF;

FIG. 11 is an explanatory view illustrating an example of a combination determination table;

FIG. 12 is a timing chart illustrating a relationship between a preceding phrase and a subsequent phrase;

FIG. 13 is a graph illustrating an example of shortening the response time when a plurality of voice synthesis threads are performed in parallel; and

FIG. 14 is a graph illustrating an example of ensuring voice output real-time performance when the plurality of voice synthesis threads are performed in parallel.

### DETAILED DESCRIPTION

<Hardware Configuration Example>

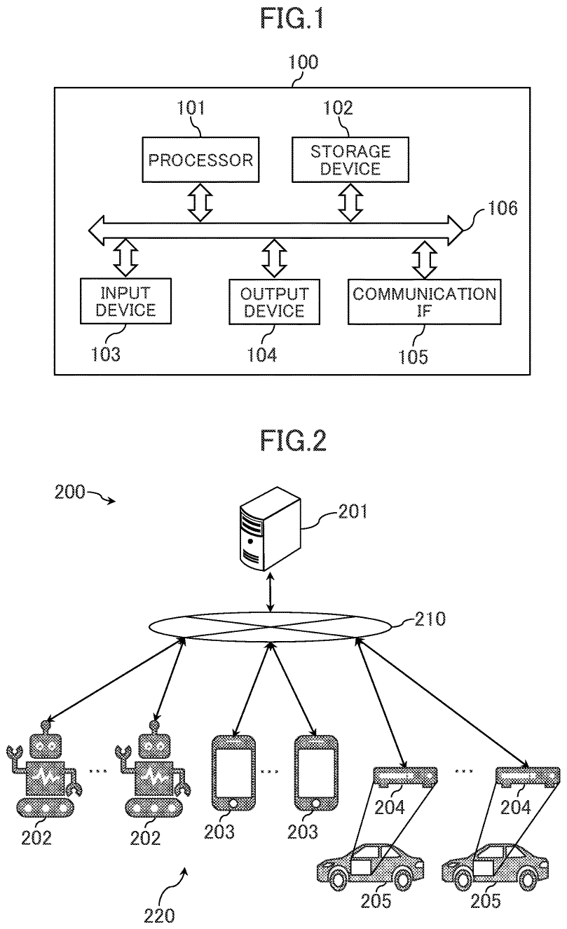

FIG. 1 is an explanatory view illustrating the hardware configuration example of a computer. A computer 100 includes a processor 101, a storage device 102, an input device 103, an output device 104, and a communication interface (a communication IF) 105. The processor 101, the storage device 102, the input device 103, the output device 104, and the communication IF 105 are connected with a bus 106. The processor 101 controls the computer 100. The storage device 102 serves as a work area of the processor 101. The storage device 102 is a non-transitory or transitory recording medium that stores various programs and data. Examples of the storage device 102 include a Read Only Memory (ROM), a Random Access Memory (RAM), a Hard Disk Drive (HDD), and a flash memory. The input device 103 inputs data. Examples of the input device 103 include a keyboard, a computer mouse, a touchscreen, a numeric keypad, a scanner, and a microphone. The output device 104 outputs data. Examples of the output device 104 include a display, a printer, and a speaker. The communication IF 105 connects to a network to transmit and receive data.

The processor 101 may be a multi-core processor. For example, the processor 101 may execute a voice synthesis thread by each core. For example, the computer 100 is a voice synthesis apparatus that is incorporated in, for example, an interactive robot 202, a personal computer 203 such as a smartphone, and a device such as a car navigation device 204 mounted on a vehicle 205, as a voice synthesis unit. While a voice synthesis function may be achieved by one computer 100, as illustrated in FIG. 2, user interfaces (the input device 103, the output device 104, and the communication IF 105) may be disposed at the terminals, hardware achieving all or a part of the voice synthesis function may be disposed at a server to configure a voice synthesis system that is communicatively connected over a network.

<System Configuration Example of Voice Synthesis System>

FIG. 2 is an explanatory view illustrating a system configuration example of the voice synthesis system. A voice synthesis system 200 includes a server 201, terminals 220 (for example, the interactive robot 202, the personal computer 203, such as the smartphone, and the car navigation device 204 mounted on the vehicle 205). The server 201 and the terminal 220 are communicatively connected over a network 210, such as the Internet, a Local Area Network (LAN), and a Wide Area Network (WAN).

The server 201 is a computer that functions as the voice synthesis apparatus. The terminal 220 is a user interface configured to input and output a voice, a text, and image data. Note that the terminal 220 itself may function as the voice synthesis apparatus in which the voice synthesis unit is incorporated.

<Voice Synthesis Process>

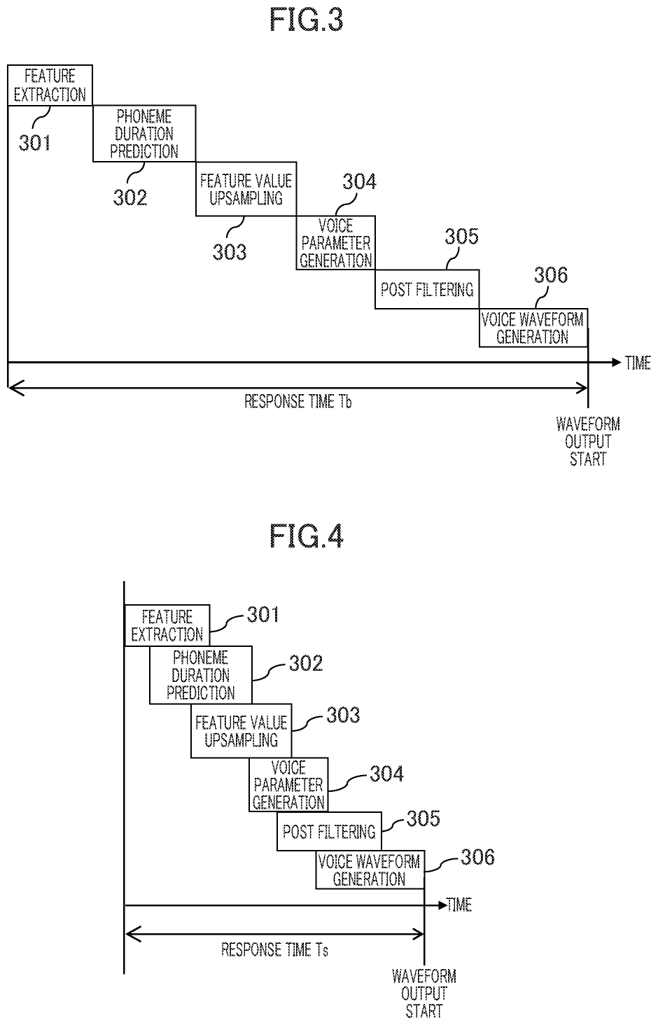

FIG. 3 is an explanatory view illustrating an internal processing example of the voice synthesis based on a DNN acoustic model by batch processing. FIG. 4 is an explanatory view illustrating an internal processing example of the voice synthesis based on the DNN acoustic model by streaming process. In FIG. 3 and FIG. 4, a feature extraction 301 is a process that extracts a feature in units of phonemes from an input intermediate language or a module that performs this process.

The intermediate language is a language expression (symbolic linguistic representation) converted from text data, and specifically, for example, includes a phonetic symbol representing a phoneme and a syllable, and a rhythm symbol representing an accent, a pause, or the like. Note that the text data may be input from the input device 103 or the communication IF 105, may be a voice recognition result of voice data input from the input device 103, or may be a dialogue sentence corresponding to the voice recognition result.

A phoneme duration prediction 302 is a process that predicts a phoneme duration based on the feature in units of phonemes extracted by the feature extraction 301 or a module that performs this process. A feature value upsampling 303 is a process that performs upsampling on a feature value in units of phrases based on the phoneme duration predicted by the phoneme duration prediction 302 or a module that performs this process.

A voice parameter generation 304 is a process that generates a voice parameter using the DNN acoustic model from the feature value in units of phrases on which the upsampling has been performed by the feature value upsampling 303 or a module that performs this process. A post filtering 305 is a process that removes a noise of the voice parameter generated by the voice parameter generation 304 or a module that performs this process.

A voice waveform generation 306 is a process that generates voice waveform data from the voice parameter from which the noise has been removed by the post filtering 305 or a module that performs this process. A voice is output from the microphone as the output device 104 based on the generated voice waveform data. A time period from a start time of the voice synthesis (a start time of the feature extraction 301) until an output start time of the voice waveform is referred to as a response time of the voice synthesis apparatus.

[Batch Processing and Streaming Process]

Generally, as illustrated in FIG. 3, in the voice synthesis by batch processing (hereinafter simply referred to as “batch processing”), the server 201 performs the feature extraction 301 to the voice waveform generation 306 in the order, and after termination of the feature extraction 301 to the voice waveform generation 306, outputs the voice waveform to the terminal 220. A response time of the batch processing is denoted as Tb. In the batch processing, the response time Tb and the process time period of the voice synthesis from the start of the feature extraction 301 until the termination of the voice waveform generation 306 are the same time period.

Meanwhile, as in FIG. 4, in the voice synthesis by streaming process (hereinafter simply referred to as “streaming process”), the server 201 performs a part and all of the modules among the feature extraction 301 to the voice waveform generation 306 in parallel. This shortens the response time. A response time of the streaming process is denoted as Ts. In a case where the voice synthesis is performed on the identical text data by the respective batch processing and streaming process, Tb>Ts is met. However, since the sentence is not entirely optimized but is locally optimized by the parallel process, the synthesis sound quality becomes lower than that in the batch processing. In the streaming process, the response time Ts becomes shorter than the process time period of the voice synthesis from the start of the feature extraction 301 until the termination of the voice waveform generation 306.

[DNN Acoustic Model Size and Process Period]

The DNN acoustic model size is one element that affects the response of the voice synthesis. The DNN acoustic model size is an index value indicative of the number of learning parameters used for the DNN acoustic model. As the number of learning parameters increases, the DNN acoustic model size increases, and as the number of learning parameters decreases, the DNN acoustic model size decreases. The number of learning parameters is determined by the number of layers of the DNN acoustic model and the number of units in each layer.

While the synthesis sound quality tends to be high as the number of learning parameters of the DNN acoustic model increases, the process time period of the voice synthesis lengthens. Specifically, for example, in FIG. 3 and FIG. 4, the process time periods of both modules of the phoneme duration prediction 302 and the voice parameter generation 304 lengthen. In the voice synthesis based on the actual DNN acoustic model, both processes of the phoneme duration prediction 302 and the voice parameter generation 304 occupy the most part (80% or more) of all processes. Especially, in the batch processing, the DNN acoustic model size significantly affects the response time Tb.

[Voice Output Real-Time Performance]

In this embodiment, reproduction of a voice without an interruption is referred to as voice output real-time performance. The voice output real-time performance is important for the voice synthesis apparatus.

FIG. 5 is an explanatory view illustrating real-time performance of the voice synthesis by batch processing. Since the response time Tb shortens in the batch processing, the synthesis process (the feature extraction 301 to the voice waveform generation 306) are performed in units of phrases. In this case, since the voice is output after generation of the voice waveform of all phrases, the voices of phrases are not interrupted during phrase reproduction.

However, in a case where the process time periods of the voice synthesis of the second and later phrases lengthen, a soundless section lengthens. In view of this, although an audient possibly has an uncomfortable feeling like the voice being interrupted due to lengthening a pause, the voice output real-time performance can be maintained.

Since the streaming process reproduces the voice while performing the voice synthesis of the phrases, in a case where a length of the voice waveform of the generated phrases (a voice length, namely, a reproduction time period) is shorter than a required time period until the voice waveform is generated, that is, the process time period of the voice synthesis of the phrases, the voice waveform generated by the voice waveform generation 306 is not in time for reproduction, and thus the voice is interrupted.

Here, a ratio of the process time period of the voice synthesis of the phrases to the voice length (the process time period/the voice length) is referred to as a real-time factor (RTF). The smaller the RTF is, the more the burden on the voice synthesis apparatus is reduced. In the streaming process, to maintain the voice output real-time performance, the RTF always need to be 1.0 or less.

[Relationship Between Response Time, Burden on Voice Synthesis Device, and Synthesis Sound Quality]

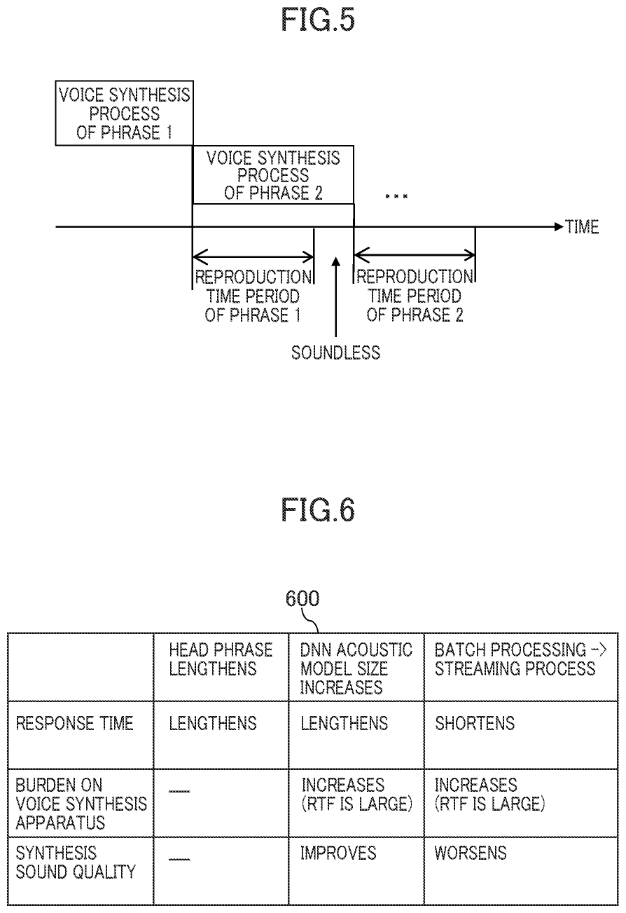

FIG. 6 is a table showing the relationship between the response time, the burden on the voice synthesis apparatus, and the synthesis sound quality; and the head phrase length, the model size, and the process method for voice synthesis. In a table 600, when the head phrase length lengthens, the response time lengthens. The increase in DNN acoustic model size lengthens the response time, increases the burden on the voice synthesis apparatus (the RTF is large), and improves the synthesis sound quality. Changing a process method for the voice synthesis (hereinafter referred to as a synthesis method) from the batch processing to the streaming process shortens the response time, increases the burden on the voice synthesis apparatus, and worsens the synthesis sound quality.

<Functional Configuration Example of Voice Synthesis Device>

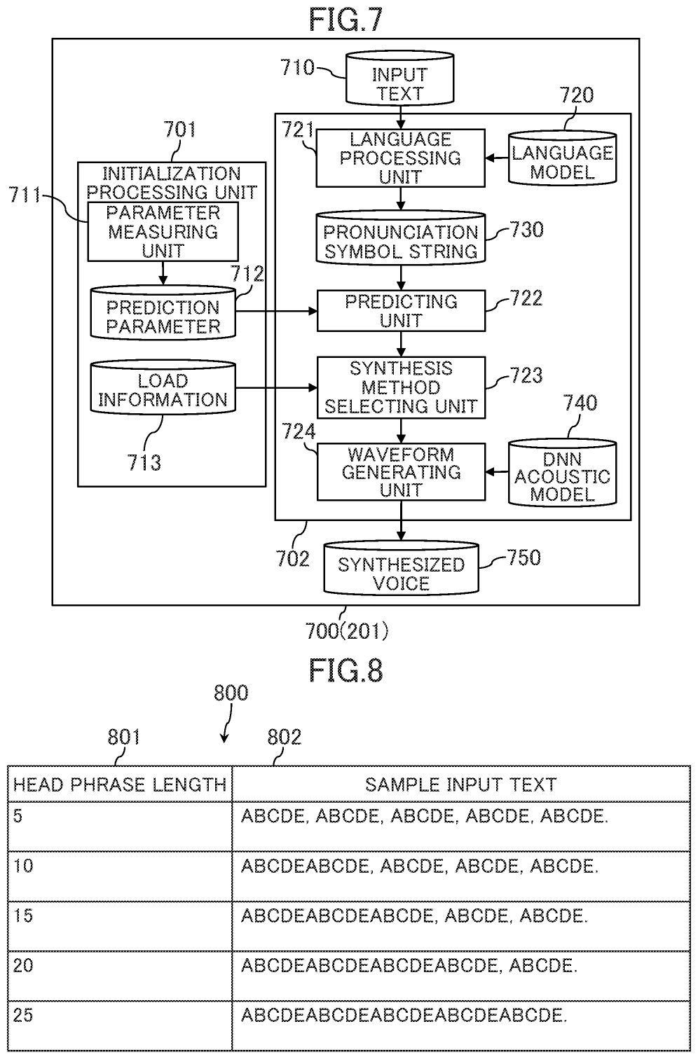

FIG. 7 is a block diagram illustrating a functional configuration example of the voice synthesis apparatus. A voice synthesis apparatus 700 (for example, the server 201) includes an initialization processing unit 701 and a synthesis process unit 702. Specifically, the initialization processing unit 701 and the synthesis process unit 702 are achieved by, for example, causing the processor 101 to execute programs stored in the storage device 102 illustrated in FIG. 1.

The initialization processing unit 701 includes a parameter measuring unit 711. Before the operation of the voice synthesis, the parameter measuring unit 711 measures the response time and the RTF of a sample input text for each combination of the DNN acoustic model size and the synthesis method. FIG. 8 illustrates an example of the sample input text used in the parameter measuring unit 711.

[Sample Input Text]

FIG. 8 is an explanatory view illustrating an example of a sample input text table. A sample input text table 800 is stored in the storage device 102, and is accessible by the processor 101. The sample input text table 800 is a table that makes head phrase lengths 801 correspond to sample input texts 802.

The head phrase length 801 is the number of morae of the head phrase in the sample input text 802. Specifically, for example, the head phrase is from the first character in the sample input text 802, “A” to the period appearing first “.” or the comma “,”, and the number of morae of the head phrase is counted as the head phrase length 801. In FIG. 8, there are five types of the head phrase lengths 801 (the number of morae), “5,” “10,” “15,” “20,” and “25,” but the number of types is not limited to five. Additionally, the head phrase lengths 801 (the number of morae) are multiples of 5, but are not limited to the multiples of 5 and not necessary to be multiples.

The sample input text 802 is the sample of the input text to measure the response time and the RTF. The sample input text 802 is constituted of a plurality of patterns having the different head phrase lengths. Unlike a waveform concatenation method, since the synthesis process time period does not depend on the type of the phoneme in the voice synthesis based on the statistical acoustic model, such as the DNN acoustic model, measurement using the sample input text 802 whose contents have no meaning like “ABODE, . . . ” is also possible. While the number of morae of the sample input text 802 is set to “25,” the sample input text 802 with the number of morae different from “25” may be present.

In the parameter measuring unit 711, the combination between the DNN acoustic model size and the synthesis method is a combination of the DNN acoustic model size (for example, three stages of “large,” “medium,” and “small”) and the synthesis method (the two types of the batch processing and the streaming process). In this example, patterns of six combinations are present. The initialization processing unit 701 inputs the respective sample input texts 802 having the different head phrase lengths 801 for each combination pattern, performs the feature extraction 301 to the voice waveform generation 306, and measures the response times Tb, Ts and the RTF.

[Measurement Results]

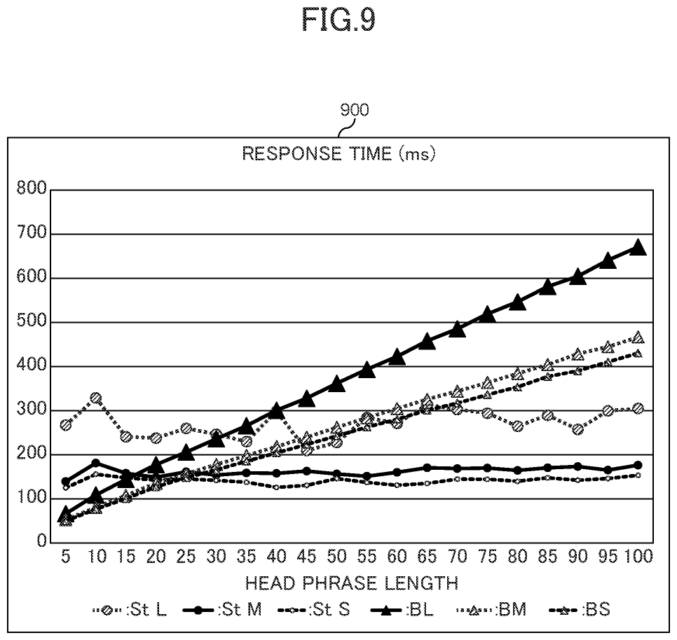

FIG. 9 is a graph illustrating the measurement results of the response times. A response time measurement result graph 900 is response information showing a relationship between the response time from the input of the phrase until the output of the phrase and the phrase length indicative of the length of this phrase. The horizontal axis plots the head phrase length 801 (the number of morae), and the vertical axis plots the response times Tb, Ts.

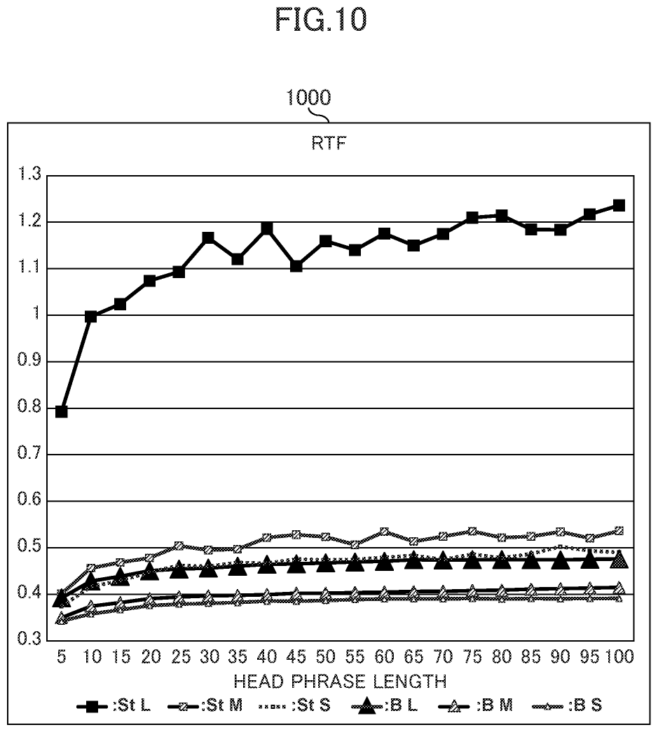

FIG. 10 is a graph illustrating measurement results of the RTF. A RTF measurement result graph 1000 is real-time factor property information showing a relationship between the phrase length indicative of the length of the phrase of the voice and the real-time factor (RTF) in each of a plurality of the synthesis methods. The horizontal axis plots the head phrase length 801 (the number of morae), and the vertical axis plots the RTF (the process time period of the sample input text 802/the voice length of the sample input text 802).

In the legends of the waveforms illustrated in FIG. 9 and FIG. 10, “St” indicates the stream process and “B” indicates the batch processing. “L” indicates the large DNN acoustic model size, “M” indicates the medium DNN acoustic model size, and “S” indicates the small DNN acoustic model size. For example, “St L” indicates the combination pattern of the stream process with the large DNN acoustic model size. The storage device 102 stores the response time measurement result graph 900 and the RTF measurement result graph 1000 as prediction parameters 712.

While FIG. 9 and FIG. 10 illustrate the measurement results of the response time and the RTF with respect to the head phrase length, the measurement results may be with respect to the phrase length of the phrase subsequent to the head phrase. FIG. 9 and FIG. 10 are expressed as the response time measurement result graph 900 and the RTF measurement result graph 1000, linear approximation may be applied for expression with functions.

The parameter measuring unit 711 measures load information 713, such as a usage percentage of the processor 101 (hereinafter referred to as a CPU usage percentage) and a usage percentage of a memory in the storage device 102 used for voice synthesis (hereinafter referred to as a memory usage percentage) and stores them in the storage device 102 as the load information 713.

Next, the synthesis process unit 702 will be described. The synthesis process unit 702 includes a language processing unit 721, a predicting unit 722, a synthesis method selecting unit 723, and a waveform generating unit 724.

The language processing unit 721 performs a process of converting an input text 710 into a pronunciation symbol string 730 with reference to a language model 720. Since the language processing unit 721 and the language model 720 are known modules, details thereof will be omitted.

The predicting unit 722 obtains a phrase length of a voice synthesis target phrase (for example, the head phrase) from the pronunciation symbol string 730 and performs a process of predicting the response time and the RTF of the voice synthesis target phrase in the input text 710 using the prediction parameter 712. Specifically, for example, the predicting unit 722 identifies the response time corresponding to the obtained phrase length from the response time measurement result graph 900. The predicting unit 722 identifies the RTF corresponding to the obtained phrase length from the RTF measurement result graph 1000.

The synthesis method selecting unit 723 selects the synthesis method applied to the voice synthesis target phrase in the input text 710 among the plurality of the synthesis methods in combination of the sizes of DNN acoustic models 740 with the voice synthesis processes based on at least one of the four indexes, the voice output real-time performance (RTF), the response time, the burden on the voice synthesis apparatus 700, and the synthesis sound quality.

Each of the plurality of synthesis methods is a combination of any of two or more kinds of sizes (three kinds of sizes “large,” “medium,” and “small” prepared in advance in this embodiment) of the DNN acoustic model 740 with any of the voice synthesis processes of the batch processing and the streaming process.

First, a case where the synthesis method for the voice synthesis target phrase is selected based on the voice output real-time performance (RTF) as the first index will be described. When the RTF predicted by the predicting unit 722 is larger than 1.0, the synthesis method selecting unit 723 decreases the size of the DNN acoustic model 740 than that in the current synthesis method such that the RTF becomes 1.0 or less, or when the current synthesis method is the streaming process, the synthesis method selecting unit 723 changes the streaming process to the batch processing. This allows changing a state of the voice output real-time performance being absent to a state of the voice output real-time performance being present.

When the RTF is 1.0 or less, the synthesis method selecting unit 723 increases the size of the DNN acoustic model 740 than that in the current synthesis method within a range of the RTF not exceeding 1.0, or when the current synthesis method is the batch processing, the synthesis method selecting unit 723 may change the batch processing to the streaming process. This allows improvement in the synthesis sound quality while maintaining the state in which the voice output real-time performance is present.

Next, a case where the synthesis method for the voice synthesis target phrase is selected based on the response time as the second index will be described. When the response time predicted by the predicting unit 722 is longer than a predetermined time period, the synthesis method selecting unit 723 decreases the size of the DNN acoustic model 740 than that in the current synthesis method such that the response time becomes equal to or less than the predetermined time period, or when the current synthesis method is the streaming process, the synthesis method selecting unit 723 changes the streaming process to the batch processing. This allows improvement in responsiveness of the output voice.

When the response time is equal to or less than the predetermined time period, the synthesis method selecting unit 723 increases the size of the DNN acoustic model 740 than that in the current synthesis method within a range of the response time not exceeding the predetermined time period, or when the current synthesis method is the batch processing, the synthesis method selecting unit 723 may change the batch processing to the streaming process. This allows improvement in the synthesis sound quality while maintaining the responsiveness of the output voice.

Next, a case where the synthesis method for the voice synthesis target phrase is selected based on the burden (a free resource) on the voice synthesis apparatus 700 as the third index will be described. When the free resource is equal to or less than a predetermined resource, the synthesis method selecting unit 723 may decrease the size of the DNN acoustic model 740 than that in the current synthesis method such that the free resource becomes equal to or more than the predetermined resource, or when the current synthesis method is the streaming process, the synthesis method selecting unit 723 changes the streaming process to the batch processing. This allows the load reduction of the voice synthesis apparatus 700.

When the free resource exceeds the predetermined resource, the synthesis method selecting unit 723 increases the size of the DNN acoustic model 740 than that in the current synthesis method within a range of the free resource not becoming the predetermined resource or less, or when the current synthesis method is the batch processing, the synthesis method selecting unit 723 may change the batch processing to the streaming process. This allows improvement in the synthesis sound quality while reducing the load on the voice synthesis apparatus 700.

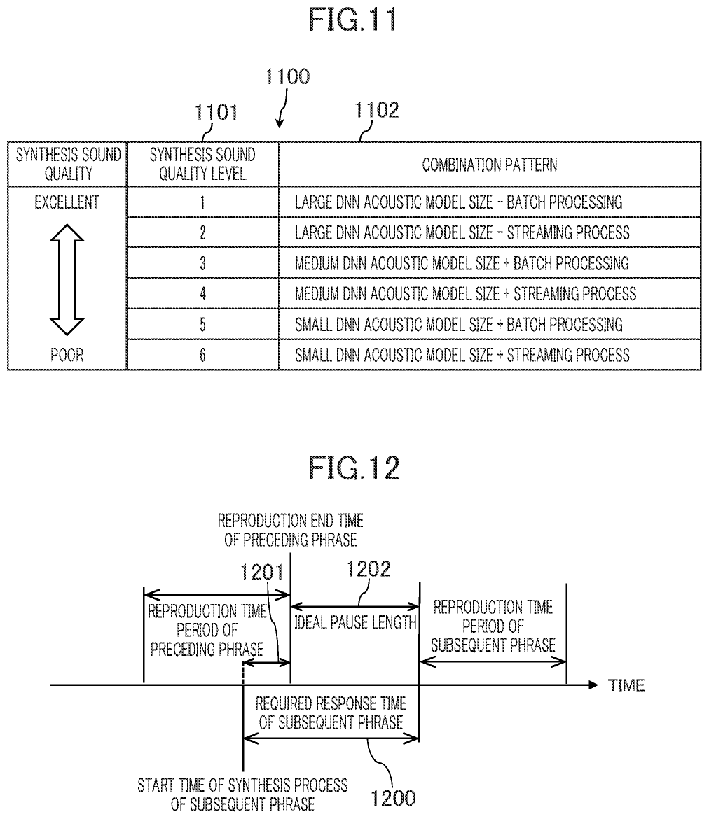

Next, a case where the synthesis method for the voice synthesis target phrase is selected based on the synthesis sound quality of the voice synthesis apparatus 700 as the fourth index will be described. When the synthesis sound quality applied, a combination determination table 1100 illustrated in FIG. 11 is applicable. Since objective evaluation of the synthesis sound quality is difficult, experientially, it is assumed that an influence from the size of the DNN acoustic model 740 is larger than an influence from the process method, and the synthesis method selecting unit 723 determines the combination between the size of the DNN acoustic model 740 and the synthesis method.

[Combination Determination Table 1100]

FIG. 11 is an explanatory view illustrating an example of the combination determination table 1100. The combination determination table 1100 is a table set based on the relationship shown in the table 600. The combination determination table 1100 is stored in the storage device 102 and is accessible by the processor 101.

The combination determination table 1100 is a table making a synthesis sound quality level 1101 correspond to a combination pattern 1102. As an example, six stages are prepared as the synthesis sound quality levels 1101, “1” indicates the best synthesis sound quality and “6” indicates the worst synthesis sound quality. The combination pattern 1102 indicates a combination between the DNN acoustic model size and the synthesis method.

The synthesis method selecting unit 723 refers to the combination determination table 1100 to identify the synthesis sound quality level 1101 corresponding to the current combination pattern 1102. The current combination pattern 1102 may be a combination of the DNN acoustic model size with the synthesis method set by default or by user's operation.

For example, when the synthesis method selecting unit 723 receives an instruction of increasing the synthesis sound quality from the terminal 220 or the input device 103, the synthesis method selecting unit 723 increases the size of the DNN acoustic model 740 more than that in the current synthesis method such that the synthesis sound quality becomes higher than the current synthesis sound quality level 1101 or changes the current synthesis process (the streaming process, the batch processing). This allows improvement in synthesis sound quality.

When the synthesis method selecting unit 723 receives an instruction of decreasing the synthesis sound quality from the terminal 220 or the input device 103, the synthesis method selecting unit 723 decreases the size of the DNN acoustic model 740 more than that in the current synthesis method such that the synthesis sound quality becomes lower than the current synthesis sound quality level 1101 or changes the current synthesis process (the streaming process, the batch processing). This allows the load reduction of the voice synthesis apparatus 700.

The waveform generating unit 724 performs the voice synthesis by the synthesis method selected by the synthesis method selecting unit 723 using the existing DNN acoustic model 740 and outputs a synthesized voice 750. The waveform generating unit 724, specifically, for example, performs the feature extraction 301 to the voice waveform generation 306 illustrated in FIG. 3 and FIG. 4 and outputs the synthesized voice 750.

Here, the synthesis method selecting unit 723 will be further specifically described. For example, the synthesis method selecting unit 723 fixes priority orders to the four indexes, the voice output real-time performance (RTF), the response time, the burden on the voice synthesis apparatus 700, and the synthesis sound quality to select the optimal synthesis method. The four indexes need not to be applied all, and at least one of them only needs to be applied.

The following will actually describe the synthesis method selection example by the synthesis method selecting unit 723 with voice interaction content as an example. The synthesis method selecting unit 723 selects the synthesis method based on the priority orders of the voice output real-time performance (effect: the voice is not interrupted)>the response time (effect: the user experience is improved)>the burden on the voice synthesis apparatus 700 (effect: cost reduction)=synthesis sound quality (effect: the user experience is improved). The following will describe them in the higher priority order.

[Head Phrase]

First, the predicting unit 722 removes the method not having the voice output real-time performance for the head phrase. The synthesis method selecting unit 723 refers to the RTF measurement result graph 1000 in FIG. 10 with respect to the head phrase in the input text 710 to predict the RTF in each synthesis method (St L, St M, St S, B L, B M, B S). For example, when the head phrase has 25 morae, the RTF is 1.1 in St L and the RTF is 0.5 in St M.

The synthesis method selecting unit 723 refers to the load information 713, obtains the CPU usage percentage, compares the CPU resource (1−CPU usage percentage) of the processor 101 with the RTF of each synthesis method, and removes the synthesis method not having the voice output real-time performance. The synthesis method not having the voice output real-time performance is a synthesis method meeting the CPU resource <RTF.

For example, with the CPU resource of 0.8, the synthesis method selecting unit 723 removes all synthesis methods with the RTF=0.8 or more and selects the appropriate synthesis method according to the priority orders at and after the response time among the synthesis methods with RTF=less than 0.8.

Meanwhile, when it is determined that the voice output real-time performance is absent in all synthesis methods, the synthesis method selecting unit 723 attempts the following two countermeasures.
Countermeasure 1: in a case where the plurality of voice synthesis threads are performed in parallel, when all of the synthesis methods are RTF=0.8 or more for the voice synthesis thread as the selection target (hereinafter referred to as a target voice synthesis thread), the synthesis method selecting unit 723 lowers the amounts of calculation of the other voice synthesis threads other than the target voice synthesis thread among the plurality of voice synthesis threads (that is, the RTF is 1.0 or less) until the CPU usage percentage comes to a level where real-time voice synthesis can be performed (for example, the DNN acoustic model sizes are reduced). After that, the synthesis method selecting unit 723 continues the selection of the synthesis method for the target voice synthesis thread according to the priority orders at and after the voice output real-time performance. When the plurality of voice synthesis threads are not performed in parallel, the synthesis method selecting unit 723 attempts countermeasure 2.
Countermeasure 2: in the batch processing, the audient feels that the voice is interrupted due to discontinuation at the soundless part, and therefore the audient does not feel the discontinuation of the voice by a bodily sensation. Accordingly, the synthesis method selecting unit 723 leaves only the synthesis methods of the batch processing (B L, B M, B S) among all synthesis methods with the RTF=0.8 or more and continues the selection of the synthesis method according to the priority orders at and after the response time. However, in this case, since the selection candidates are only the batch processing, the response time becomes longer than that of the stream process in some cases.

After the countermeasure 1 or the countermeasure 2 is taken, the synthesis method selecting unit 723 removes the combination pattern (the combination of the DNN acoustic model size and the synthesis method) not meeting the predetermined response time preliminarily designated by the user. That is, the synthesis method selecting unit 723 selects the synthesis method of the combination pattern with the shortest response time among the combination patterns meeting the predetermined response time. Meanwhile, when the combination pattern meeting the predetermined response time is absent, the synthesis method selecting unit 723 may select the synthesis method with the shortest response time.

In the case where the combination pattern meeting the predetermined response time is absent, the synthesis method selecting unit 723 may prioritize the burden on the voice synthesis apparatus 700 and the synthesis sound quality preliminarily designated by the user. To prioritize the burden on the voice synthesis apparatus 700, the synthesis method selecting unit 723 selects the synthesis method of the combination pattern in which the RTF becomes the minimum. To prioritize the synthesis sound quality, the synthesis method selecting unit 723 selects the synthesis method of the combination pattern in which the synthesis sound quality level is the highest.

[Subsequent Phrase]

While the response time of the voice synthesis apparatus 700 depends on only the head phrase length, the voice output real-time performance of the entire sentence also depends on the second and later subsequent phrases. For example, when the head phrase is short and the second phrase is long, even when the reproduction of the head phrase terminates, the voice waveform is not generated by the synthesis process of the second phrase and the voice is interrupted in some cases.

In this case, since the soundless section is generated at a phrase boundary, the discontinuation of the voices is often not perceived aurally. However, there may be a case where the pause unnaturally lengthens, resulting in affecting naturalness of the entire voice. Especially, in the interaction voice, a change in the length of the pause possibly affects a nuance of a voice. Accordingly, the length of the pause predicted by the statistical acoustic model need to be held and the response times of the subsequent phrases also need to be predicted.

FIG. 12 is a timing chart illustrating a relationship between a preceding phrase and the subsequent phrase. The preceding phrase is a phrase one prior to the subsequent phrase. A required response time 1200 required for the synthesis process of the subsequent phrase is not a required response time designated by the user but is a time period of adding an ideal pause time period 1202 to a difference 1201 between the start time of the synthesis process of the subsequent phrase and the reproduction termination time of the preceding phrase.

Accordingly, in the synthesis process of the subsequent phrase, the synthesis method selecting unit 723 may select the synthesis method in which the response time of the subsequent phrase becomes the required response time 1200 or less, and may apply the synthesis method selected in the head phrase to the synthesis method in the subsequent phrase. Whether to sequentially select the synthesis method in the synthesis process of the subsequent phrase may be preliminarily set to the voice synthesis apparatus 700.

<Parallel Execution of a Plurality of Voice Synthesis Threads>

Here, a description of shortening of the response time of the voice synthesis and ensuring the voice output real-time performance when the voice synthesis apparatus 700 performs a plurality of voice synthesis threads in parallel will be described.

[Shortening of Response Time]

To shorten the response time of the new voice synthesis thread, the synthesis method selecting unit 723 can decrease the CPU usage percentage and select the synthesis method with further high responsiveness.

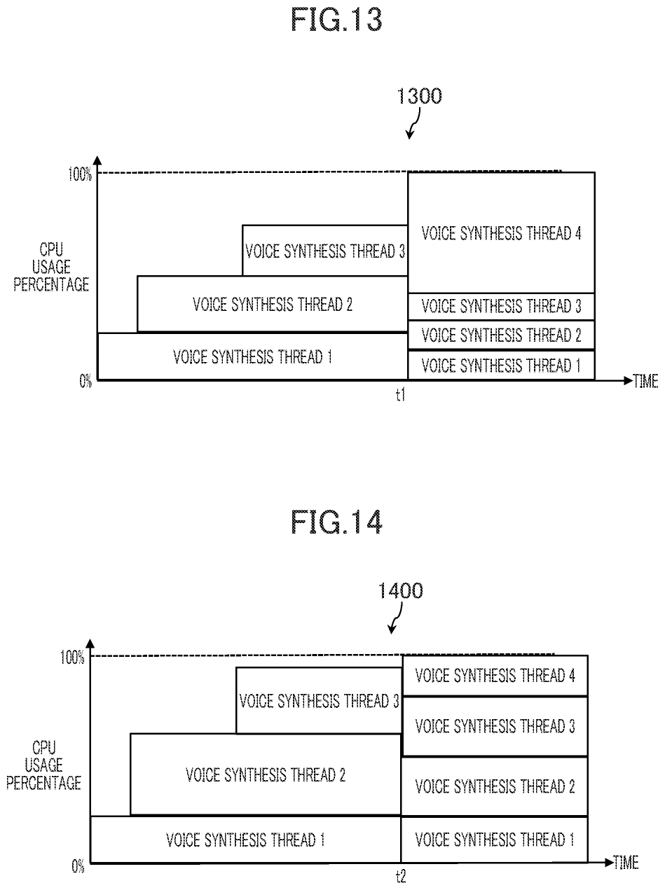

FIG. 13 is a graph illustrating an example of shortening the response time when the plurality of voice synthesis threads are performed in parallel. In a graph 1300, the horizontal axis plots the time period and the vertical axis plots the CPU usage percentage. Voice synthesis threads 1 to 4 are processes performed in the voice synthesis apparatus by voice input from the different terminals 220 and the voice is output from the different terminals 220.

Assume that the voice synthesis thread 4 is added at a time t1 during the parallel execution of the voice synthesis threads 1 to 3. In this case, the synthesis method selecting unit 723 switches the synthesis method for the voice synthesis threads 1 to 3 in process to the synthesis method with the further low RTF to reduce the total CPU usage percentage of the voice synthesis threads 1 to 3. For example, the synthesis method selecting unit 723 decreases the DNN acoustic model sizes of the voice synthesis threads 1 to 3 and when the synthesis method for the voice synthesis threads 1 to 3 is the streaming process, the synthesis method selecting unit 723 switches the streaming process to the batch processing.

At this time, the synthesis method selecting unit 723 performs control such that the CPU resource (1−CPU usage percentage) becomes larger than the total CPU usage percentage of the voice synthesis threads 1 to 3 in process. Thus, the synthesis method selecting unit 723 allows selecting the synthesis method with further high CPU load for the new voice synthesis thread 4 and allows high-quality synthesized voice.

[Ensuring Voice Output Real-Time Performance]

FIG. 14 is a graph illustrating an example of ensuring the voice output real-time performance when a plurality of voice synthesis threads are performed in parallel. In a graph 1400, the horizontal axis plots the time and the vertical axis plots the CPU usage percentage. The voice synthesis threads 1 to 4 are processes performed in the voice synthesis apparatus by voice input from the different terminals 220 and the voice is output from the different terminals 220.

Assume that the voice synthesis thread 4 is added at a time t2 during the parallel execution of the voice synthesis threads 1 to 3. In a case where the total CPU usage percentage of the voice synthesis threads 1 to 3 in process is high and the new voice output real-time performance cannot be ensured using the remaining CPU resource, the synthesis method selecting unit 723 switches the synthesis method for the voice synthesis threads 1 to 3 in process to the synthesis method with the low RTF to reduce the total CPU usage percentage of the voice synthesis threads 1 to 3.

At this time, to maintain the voice output real-time performance of the new voice synthesis thread 4, the synthesis method selecting unit 723 reduces the total CPU usage percentage of the voice synthesis threads 1 to 3 such that the RTF of the new voice synthesis thread 4 becomes 1.0 or less. For example, the synthesis method selecting unit 723 decreases the DNN acoustic model sizes of the voice synthesis threads 1 to 3, or when the synthesis method for the voice synthesis threads 1 to 3 is the streaming process, the synthesis method selecting unit 723 switches the streaming process to the batch processing.

At this time, the synthesis method selecting unit 723 selects a combination pattern in which the synthesis method for the new voice synthesis thread 4 is the streaming process and the DNN acoustic model size is low (for example, “small”) where the CPU usage percentage is equal to or less than the remaining CPU resource. This allows ensuring the voice output real-time performance of the voice synthesis thread 4.

The above-described voice synthesis apparatus 700 can be configured as (1) to (12) below.

(1) The voice synthesis apparatus 700 that performs the voice synthesis based on the statistical acoustic model (for example, the DNN acoustic model 740) includes the processor 101 and the storage device 102. The processor 101 executes the program. The storage device 102 stores the program. The processor 101 executes: the selection process that selects the synthesis method applied to the input voice among the plurality of synthesis methods in combination of the sizes of the statistical acoustic models with the voice synthesis processes (the batch processing or the streaming process) based on the input voice by the synthesis method selecting unit 723; and the synthesis process that synthesizes the input voice by the synthesis method selected in the selection process by the waveform generating unit 724.

This allows optimizing the voice output timing of the synthesized voice 750 synthesized by the synthesis method appropriate for the input voice.

(2) In the voice synthesis apparatus 700 according to (1), each of the plurality of synthesis methods is the combination of any of the two or more kinds of the sizes (for example, “large,” “medium,” and “small”) of the statistical acoustic models with any one of the voice synthesis processes of the batch processing and the streaming process.

The combination of the size of the statistical acoustic model with the voice synthesis process allows controlling the response time, the burden on the voice synthesis apparatus 700, and the synthesis sound quality.

(3) In the voice synthesis apparatus 700 according to (1), the voice synthesis apparatus 700 is accessible to the real-time factor property information indicative of the relationship between the phrase length indicating the length of the phrase of the voice and the real-time factor (RTF) in each of the plurality of synthesis methods. The real-time factor is the information indicative of the real-time performance of the voice output by the ratio of the process time period of the voice synthesis of the phrase to the voice length as the reproduction time period of the phrase. The processor 101 executes: the predicting process that predicts the real-time factor of the voice synthesis target phrase from the phrase length indicative of the length of the voice synthesis target phrase of the input voice based on the real-time factor property information in each of the plurality of synthesis methods by the predicting unit 722; and the selection process that selects the synthesis method applied to the voice synthesis target phrase among the plurality of synthesis methods based on the prediction result by the predicting process.

This allows improving the voice output timing at which the synthesized voice 750 is not in time for reproduction and is interrupted.

(4) In the voice synthesis apparatus 700 according to (3), in the selection process, the processor 101 determines the presence/absence of the real-time performance of the voice output of the voice synthesis target phrase based on the free resource in the voice synthesis apparatus 700 at the input of the voice synthesis target phrase and the real-time factor of the voice synthesis target phrase in each of the plurality of synthesis methods and selects the synthesis method applied to the voice synthesis target phrase among the synthesis methods determined as having the real-time performance.

This allows removing the synthesis method in which the voice output timing becomes the timing at which the synthesized voice 750 is not in time for reproduction and interrupted from the selection candidate.

(5) In the voice synthesis apparatus 700 according to (4), in the selection process, in a case where the real-time performance of the voice output of the voice synthesis target phrase is determined as absent in each of the plurality of synthesis methods, when the processor 101 executes the synthesis process and another synthesis process in parallel, the processor 101 executes control such that the size of the statistical acoustic model in the other synthesis method selected in the other synthesis process decreases, and selects the synthesis method applied to the voice synthesis target phrase among the plurality of synthesis methods.

This allows operating the other synthesis process to improve the voice output timing in the synthesis process.

(6) In the voice synthesis apparatus 700 according to (4), in the selection process, when the real-time performance of the voice output of the voice synthesis target phrase is determined as absent in each of the plurality of synthesis methods, the processor 101 selects the synthesis method applied to the voice synthesis target phrase among the synthesis methods including the batch processing among the plurality of synthesis methods.

This allows removing the synthesis method that employs the voice synthesis process in which the voice output timing becomes the timing at which the synthesized voice 750 is not in time for reproduction and interrupted from the selection candidate.

(7) In the voice synthesis apparatus 700 according to (1), the voice synthesis apparatus 700 is accessible to the response information (the response time measurement result graph 900) indicative of the relationship between the response time from the input of the phrase of the voice until the output of the phrase of the voice and the phrase length indicative of the length of the phrase of the voice in each of the plurality of synthesis methods. The processor 101 executes: the predicting process that predicts the response time of the voice synthesis target phrase from the phrase length indicative of the length of the voice synthesis target phrase of the input voice based on the response information in each of the plurality of synthesis methods; and the selection process that selects the synthesis method applied to the voice synthesis target phrase among the plurality of synthesis methods based on the prediction result by the predicting process.

This allows improvement in responsiveness of the synthesized voice 750.

(8) In the voice synthesis apparatus 700 according to (1), in the selection process, the processor 101 selects the synthesis method applied to the voice synthesis target phrase among the plurality of synthesis methods based on the free resource in the voice synthesis apparatus 700 at the input of the voice synthesis target phrase in the input voice.

This allows the load reduction of the voice synthesis apparatus 700.

(9) In the voice synthesis apparatus 700 according to (1), in the selection process, the processor 101 selects the synthesis method applied to the voice synthesis target phrase among the plurality of synthesis methods based on the synthesis method applied to the preceding phrase that precedes the voice synthesis target phrase in the input voice.

This allows improvement in synthesis sound quality.

(10) In the voice synthesis apparatus 700 according to (7), in the selection process, the processor 101 selects the synthesis method applied to the voice synthesis target phrase among the plurality of synthesis methods based on the difference 1201 between the start time of the synthesis process of the voice synthesis target phrase and the reproduction end time of the preceding phrase that precedes the voice synthesis target phrase and the ideal pause time period 1202 from the reproduction end time of the preceding phrase until the reproduction start time of the voice synthesis target phrase.

This allows reducing redundancy of an unnatural pause between phrases, ensuring smoothing interaction.

(11) In the voice synthesis apparatus 700 according to (3), in the selection process, when another synthesis process (the voice synthesis thread 4) regarding another input voice is added, the processor 101 selects the synthesis method in which the real-time factor becomes smaller than the real-time factor in the synthesis method applied to the input voice.

This allows ensuring the voice output real-time performance of the other synthesis process (the voice synthesis thread 4).

(12) In the voice synthesis apparatus 700 according to (7), in the selection process, when another synthesis process regarding another input voice is added, the processor 101 selects the synthesis method in which the response time becomes smaller than the response time in the synthesis method applied to the input voice.

This allows selecting the synthesis method with the further high CPU load for the new voice synthesis thread 4 and allows the high-quality synthesized voice.

The present invention is not limited to the above-described embodiments, and includes various modifications and equivalent configurations within the scope of the accompanying claims. For example, the above-described embodiments are described in detail for simply describing the present invention, and the present invention is not necessarily limited to ones that include all the described configurations. A part of the configuration of one embodiment may be replaced by a configuration of another embodiment. A configuration of another embodiment may be added to the configuration of one embodiment. Regarding a part of the configurations in each embodiment, another configuration may be added, deleted, or replaced.

Each configuration, function, processing unit, processing means, and the like described above may be achieved by hardware by, for example, designing a part or all of them with, for example, an integrated circuit or may be achieved by software by the processor 101 interpreting and executing a program that achieves each function.

Information of the program that achieves each function, tables, files, and the like can be stored in a memory device, such as a memory, a hard disk, and a Solid State Drive (SSD), or a recording medium of an Integrated Circuit (IC) card, an SD card, and a Digital Versatile Disc (DVD).

Control lines and information lines considered to be necessary for description are described, and all control lines and all information lines required for mounting are not necessarily described. In practice, almost all the configurations may be considered to be mutually connected.

What is claimed is:

1. A voice synthesis apparatus that performs voice synthesis based on a statistical acoustic model, the voice synthesis apparatus comprising:
a processor that executes a program; and
a storage device that stores the program, wherein
the processor executes:
a selection process that selects a synthesis method applied to an input voice among a plurality of synthesis methods in combination of sizes of the statistical acoustic models with voice synthesis processes based on the input voice; and
a synthesis process that synthesizes the input voice by the synthesis method selected in the selection process.

2. The voice synthesis apparatus according to claim 1, wherein
each of the plurality of synthesis methods is a combination of any of two or more kinds of the sizes of the statistical acoustic models with any one of the voice synthesis processes of the batch processing and the streaming process.

3. The voice synthesis apparatus according to claim 1, wherein
the voice synthesis apparatus is accessible to real-time factor property information indicative of a relationship between a phrase length indicating a length of a phrase of a voice and a real-time factor in each of the plurality of synthesis methods, and the real-time factor is information indicative of a real-time performance of a voice output by a ratio of a process time period of voice synthesis of the phrase to a voice length as a reproduction time period of the phrase, and
the processor executes:
the predicting process that predicts the real-time factor of a voice synthesis target phrase from a phrase length indicative of a length of the voice synthesis target phrase of the input voice based on the real-time factor property information in each of the plurality of synthesis methods; and
the selection process that selects a synthesis method applied to the voice synthesis target phrase among the plurality of synthesis methods based on a prediction result by the predicting process.

4. The voice synthesis apparatus according to claim 3, wherein
in the selection process, the processor determines presence/absence of the real-time performance of the voice output of the voice synthesis target phrase based on a free resource in the voice synthesis apparatus at an input of the voice synthesis target phrase and the real-time factor of the voice synthesis target phrase in each of the plurality of synthesis methods and selects a synthesis method applied to the voice synthesis target phrase among synthesis methods determined as having the real-time performance.

5. The voice synthesis apparatus according to claim 4, wherein
in the selection process, in a case where the real-time performance of the voice output of the voice synthesis target phrase is determined as absent in each of the plurality of synthesis methods, when the processor executes the synthesis process and another synthesis process in parallel, the processor executes control such that the size of the statistical acoustic model in the other synthesis method selected in the other synthesis process decreases, and selects a synthesis method applied to the voice synthesis target phrase among the plurality of synthesis methods.

6. The voice synthesis apparatus according to claim 4, wherein
in the selection process, when the real-time performance of the voice output of the voice synthesis target phrase is determined as absent in each of the plurality of synthesis methods, the processor selects a synthesis method applied to the voice synthesis target phrase among synthesis methods including batch processing in the plurality of synthesis methods.

7. The voice synthesis apparatus according to claim 1, wherein
the voice synthesis apparatus is accessible to response information indicative of a relationship between a response time from an input of a phrase of a voice until an output of the phrase of the voice and a phrase length indicative of a length of a phrase of the voice in each of the plurality of synthesis methods,
the processor executes:
the predicting process that predicts the response time of the voice synthesis target phrase from the phrase length indicative of the length of the voice synthesis target phrase of an input voice based on the response information in each of the plurality of synthesis methods; and
the selection process that selects a synthesis method applied to the voice synthesis target phrase among the plurality of synthesis methods based on a prediction result by the predicting process.

8. The voice synthesis apparatus according to claim 1, wherein
in the selection process, the processor selects a synthesis method applied to a voice synthesis target phrase among the plurality of synthesis methods based on a free resource in the voice synthesis apparatus at an input of the voice synthesis target phrase in the input voice.

9. The voice synthesis apparatus according to claim 1, wherein
in the selection process, the processor selects a synthesis method applied to a voice synthesis target phrase among the plurality of synthesis methods based on a synthesis method applied to a preceding phrase that precedes the voice synthesis target phrase in the input voice.

10. The voice synthesis apparatus according to claim 7, wherein
in the selection process, the processor selects a synthesis method applied to the voice synthesis target phrase among the plurality of synthesis methods based on a difference between a start time of the synthesis process of the voice synthesis target phrase and a reproduction end time of a preceding phrase that precedes the voice synthesis target phrase and an ideal pause time period from a reproduction end time of the preceding phrase until a reproduction start time of the voice synthesis target phrase.

11. The voice synthesis apparatus according to claim 3, wherein
in the selection process, when another synthesis process regarding another input voice is added, the processor selects a synthesis method in which the real-time factor becomes smaller than the real-time factor in the synthesis method applied to the input voice.

12. The voice synthesis apparatus according to claim 7, wherein
in the selection process, when another synthesis process regarding another input voice is added, the processor selects a synthesis method in which the response time becomes smaller than the response time in the synthesis method applied to the input voice.

13. A voice synthesis method by a voice synthesis apparatus that performs voice synthesis based on a statistical acoustic model, the voice synthesis apparatus including a processor that executes a program and a storage device that stores the program, wherein
in the voice synthesis method,
the processor executes:
a selection process that selects a synthesis method applied to an input voice among a plurality of synthesis methods in combination of sizes of the statistical acoustic models with voice synthesis processes based on the input voice; and
a synthesis process that synthesizes the input voice by the synthesis method selected in the selection process.

14. A voice synthesis program that causes a processor to perform voice synthesis based on a statistical acoustic model, the voice synthesis program causing the processor to execute:
a selection process that selects a synthesis method applied to an input voice among a plurality of synthesis methods in combination of sizes of the statistical acoustic models with voice synthesis processes based on the input voice; and
a synthesis process that synthesizes the input voice by the synthesis method selected in the selection process.
